(19) United States
(12) Patent Application Publication
(10) Pub. No.: US 2007/0181464 A1
(43) Pub. Date: Aug. 9, 2007

(54) Alkali-free demercaptanization catalist for hydrocarbon composition

(76) Inventors: Alexei Konovalov, Lamaca (CY); Vladimir Smirnov, Moscow (RU); Vladimir Konovalov, Lubertsy (RU); Irina Tarkhanova, Moscow (RU)

Correspondence Address: Ilya Zborovsky, 6 Schoolhouse Way, Dix Hills, NY, 11746, US

(21) Appl. No.: 11/505,680

(22) Filed: Aug. 18, 2006

Related U.S. Application Data
(62) Division of application No. 10/451,259, filed on Jun. 20, 2003, now Pat. No. 7,087,547.

(51) Int. Cl. C10G 45/00; C10G 17/00; B01J 31/00

(52) U.S. Cl. 208/208 R; 502/150; 502/162

(57) ABSTRACT

A catalyst is intended for the oxidative demercaptanization (sweetening) of hydrocarbons compositions including petroleum, petroleum distillates, gasolines, kerosenes, jet fuels, diesel fuels and heating oils, natural-gas liquids, etc. It may be used in a fixed-bed or fluidized-bed process. A catalyst consists of an active part and an inert component. The active part contains an oxide of a transition metal of Groups Ib, V-VIIb of the Periodic Table, either Ni, or Co oxide, or mixture of oxides of the indicated elements, and transition metal salts, and nitrogen-containing organics. The inert component is an oxide of an element of Groups IIa, IIIa, IV, or Fe oxide, or chemical compound including not less than 95% oxides of indicated elements, or mixture of the above compounds. A method for a preparation of the catalyst is following: the inert compound is impregnated with aqueous solution of transition metal salt, the resulting product is calcined in air flow for metal oxide formation, and transition metal salt and nitrogen containing organics are deposed from their solution in organic solvent.

An application of the catalyst for the oxidative demercaptanisation of hydrocarbon compositions includes passing the latter through the fixed bed or flow bed of a catalyst at 10-80° C., at pressure 9.80665*10⁴-9.80665*10⁵ Pa (1-10 at.) The demercaptanisation proceeds in the presence of air, or oxygen, or gas, containing not less than 5% of oxygen.

### BACKGROUND OF THE INVENTION

1. Field of the Invention

The invention relates to catalytic systems, consisting of an active part and inert component and intended for the oxidative demercaptanization (sweetening) of hydrocarbon compositions including petroleum, petroleum distillates, gasolines, kerosenes, jet fuels, diesel fuels and heating oils, natural-gas liquids, etc., processes for the production of the catalysts, and their use in the field mentioned above.

2. Description of the Prior Art

The oxidative demercaptanization (sweetening) of hydrocarbon compositions (e.g. petroleum distillates, fuels etc.) is well known and widely practiced process for removal of poor smelling, toxic and corrosive mercaptans and related substances. Said process is based on the oxidation of mercaptans with the formation of innocuous disulphides. Processes where the hydrocarbons have been treated by oxygen or oxygen-containing gas in the presence of homogeneous or heterogeneous metal-complex catalysts and alkaline agent (more often aqueous caustic), e.g., well known UOP MEROX process, have obtained the greatest distribution.

Catalyst for the oxidative demercaptanization should satisfy to the following main requests:

provide decrease of mercaptan sulphur concentration in the treated products to an tolerance level (usually 3-10 ppm);

stable work during long time;

not pollute a product by harmful impurities;

not contain expensive and poison components;

hydrocarbon compositions mustn't change their colour or become less stable after the treatment

Besides, it is desirable that the catalyst could be easily regenerated.

A commonly used catalyst for alkaline sweetening is cobalt phthalocyanine (see for example European patent-94571, German patent 3008284 etc.). Use of alkalies complicates the technology because of an occurrence of additional operations on the separation of water and organic phases and the clearing of waste water. Attempts to create effective non-alkaline process therefore do not cease.

A rather large number of catalysts and catalytic compositions for non-alkaline demercaptanization is known on the basis of connections of transitive metals. It was offered to use:

chelate complexes including porphyrinates of transition metals (Co, Cu, V a.o., European patent 0252853);

complexes of transition metals (e.g. Co, Cu, Ni, Fe) with three- or tetradentate ligands containing at least one amide group (French patent 2573087);

phthalocyanines of transition metals (U.S. Pat. No. 4,159,964),

complexes of transition metals with cation-exchange resins (British patent 1167017);

products of reactions between transition metal salts and tetracyanothiophene or tetracyanodithline (French patent 2591610);

cupric salts, e.g. cupric chloride, in a combination with organic acids, alkyl amines, alkanol amines, amino acids, or urea derivatives (British patent 996500).

Various oxides are often applied as inert components (supports) for heterogeneous catalysts. For example, silica, alumina, alumosilicates, zeolites are listed in French patent 2591610. The use of Si, Al, Zr, Th oxides and products of their cornbination with oxides of silicon and other elements, for example, kaolin, montmorillonite, etc., were pointed out in European patent 0252853. An active carbon, frequently with various additives, is another widespread carrier. So, active carbon, modified by phosphates, e.g., ammonium phosphates, is offered in British patent 996500 as an inert component

There is no mention in the prior art that combinations of transition metal oxides and complexes of transition metal salts with organic compounds would be effective catalytic systems for the oxidative demercaptanisation. Quite surprisingly we have found that such combinations of nitrogen-containing organic compounds gave excellent results. Thus, the present invention provides a new catalytic composition, the method of its production and its use in the oxidative demercaptanization.

### SUMMARY OF THE INVENTION

An object of this invention is to provide a new catalyst consisting of an active part and inert component and intended for the oxidative demercaptanisation (sweetening) of hydrocarbon compositions including petroleum, petroleum distillates, gasolines, kerosenes, jet fuels, diesel fuels and heating oils, natural-gas, liquids etc. The active part contains a transition metal of Groups Ib, V-VIIb of the Periodic Table, either Ni, or Co, or mixture of oxides of the indicated elements, and transition metal salts, and nitrogen-containing organic compounds. The inert component is an oxide of an element of Groups IIa, III, IV, or Fe oxide, or a chemical compound including not less than 95% oxides of indicated elements, or mixture of the above compounds.

Other objects of this invention are provide a method for preparing the above mentioned systems and their use in the oxidative demercaptanization.

### DETAILED DESCRIPTION OF THE INVENTION

The offered catalyst contains 0.2-5% oxides of a transition metal of Group Ib, Vb, VIb, VIIb of the Periodic Table, either Ni, Co oxide, or mixture of oxides of (above) the said metals. As an example, cupric oxide can be used as an element of Group Ib oxide, oxides of Nb(V), V(V) Mo(VI), Cr(III))—as oxides of elements of Groups Vb-VIIb.

The catalytic system contains also 0.5-20% of transition metal salt Co, Cu, Ni, Mn and others can be selected as transition metals. Chlorides, bromides, carboxilates and others can be used as anions in the salts.

The catalytic system contains 0.5-20% of nitrogen-containing organic compound. It may be:

a) amine, e.g., triethyl amine, tributyl amine, ethylene diamine, triethylene tetramine, pyridine;

b) amino acid, e.g. threonine, asparagine, hydroxyproline, betaine, cysteine, serine;

c) amide, e.g. formamide, dimethyl formamide, dimethyl acetamide;

d) alkanol amine, e.g. mono- di, triethanolamine or their hydroxides;

e) urea derivatives, e.g. urea and their alkyl derivatives, and combination of two or more substances from this set.

The last-named component of the catalytic system, completing its composition up to 100%, is the inert component. The inert component can be an oxide of an element of Groups IIa, III or IV or Fe oxide. An oxide of an element of Groups IIa, III-IV can be, in particular, Si, Al, Mg, Zr, Ti, or La oxide. The inert component can be also a chemical compound (in particular, silicate or zeolite), containing not less, than 95% of indicated oxides, or mixture of the above compounds.

The method for the catalyst production includes a formation of high-dispersed metal oxide on a surface of the inert component by its impregnation with the metal salts from aqueous solutions, and its thermal decomposition at high temperatures in airflow. Transition metals' nitrates, sulfates, acetates, e.g., can be used at this stage. Then the product is impregnated with a solution of a transition metal salt and nitrogen-containing organics dissolved in organic solvent. Chlorides, bromides, or carboxilates can be used at this stage. The catalyst obtained was dried up on air at ambient temperature and warmed up in airflow.

The application of the catalyst in demercaptanization process assumes passing of hydrocarbon compositions containing mercaptanes, among them petroleum, petroleum distillates, gasolines, kerosenes, jet fuels, diesel fuels and heating oils, natural-gas liquids etc., through a fixed or fluidizad bed of the catalyst at 10-80° C. in the presence of air or another oxygen-containing gas. Oxygen-containing gas is oxygen or gas with not less than 5% of oxygen. The process is carried out at normal or hightened (up to 10 at.) pressure.

### EXAMPLE

### A. Preparation of the Catalysts

SiO₂ (macroporous silica gel with a specific surface area 250 m²/g) was calcined on air within 2 hours at 450° C. Then it was treated with concentrated aqueous solution of cupric nitrate in an amount correspondent to 0.3 g CuO per 100 g of the support. The paste formed was maintained within one hour at ambient temperature on air and was calcined by hot airflow (1 hour at 100° C. and 2 hours at 550° C.). Then it was cooled up to room temperature and vacuumed. Afterwards 30% solution of DMF in acetonitrile in an amount correspondent to 14 ml DMF per 100 g of silica and 1.5% solution of CuCl₂ (5 g CuCl₂ per 100 g silica) were added under vacuum. The mixture was heated at 50° C. within 2 hours, then a solid residue was separated and treated by airflow at ambient temperature. The contents of CuCl₂ and DMF in the catalyst were calculated as a difference between the former amount of a reagent and its content in the solution after the separation of the catalyst. The received catalyst A contains 0.3% CuO, 5% DMF, and 3.5% CuCl₂.

The following catalysts were obtained by the same way:

B-CuO -1.2%, CoO-1.5%, pyridine-9%, DMF-5%, CuBr₂-6%, the rest is Al₂O₃;

C-CuO-2.5%, monoethanol amine-14%, CuCl₂-2.5%, the rest is a mixture of SiO₂ and Al₂O₃ (1:1 by weight);

D-CuO-0.2%, monoethanol amine-4%, CuCl₂-3%, the rest is alumosilicate (Al₂O₃-44%, SiO₂-54.5%, La₂O₃-1.5%);

E-CuO-0.4%, hydroxiproline-2.2%, CuCl₂-0.8%, the rest is alumosilicate (Al₂O₃-41%, SiO₂-53%, Na₂O-0.2%, MgO-1.2%, Fe₂O₃-1.6%, TiO₂-3%).

The similar catalyst F, not containing previously added transition metal oxide, was prepared for comparative tests: DMF-5%, CuCl₂-5%, the rest is SiO₂.

B. Sweettening Tests

In standart tests we used kerosene (interval of b.p. 160-2400 C.) with following parameters:

The total content of sulphur 0.19%,

The content of mercaptane sulphur—0.009-0.011%,

The acidity in mg of KOH per 100 mL of kerosene—0.63,

The content of resins in mg per 100 mL kerosene—2.5.

Kerosene with air dissolved was passed with relevant speed through a column filled with 20 g of a catalyst at the ambient temperature and normal pressure. An additional saturation of the catalyst or kerosene by oxygen was not performed. The result was considered as satisfactory, if on an output of the reactor the content of mercaptane sulphur in kerosene did not exceed 3 ppm. Copper was not detected on the output of the reactor by analytical methods with sensitivity on the metal about 0.5 ppm. An average acidity on the output was 0.22 mg KOH per 100 mL of kerosene. The content of resins and total content of sulphur after sweetening did not change. The colour of kerosene did not change. The storage of the sweetened product in metal capacities for a month did not result in change of the colour and any other deviation.

The results of the tests, representing the activity of various catalysts, are submitted in tab. 1. The activity was characterised as maximum space velocity of kerosene feeding when sweetening remained satisfactory.

TABLE 1

| Catalyst | T, ° C. | Sp. velocity, hrs⁻¹ |
|---|---|---|
| A | 25 | 25 |
| B | 25 | 35 |
| C | 25 | 40 |
| D | 25 | 60 |
| E | 25 | 55 |
| F | 25 | 15 |
| E | 40 | 60 |
| E | 63 | 60 |
| E | 80 | 48 |

It is clear from the table, that all the catalysts have high activity. Not containing metal oxide catalytic composition F gives the worse results.

The possibility of the process realization in flow-bed reactor was checked up at the catalyst D as an example. The required degree of sweetening was achieved at space speed of kerosene feeding about 60-65 hrs⁻¹. Thus, the results were not worse than for a fixed bed catalyst. The preliminary saturation of kerosene by oxygen allowed increasing the speed of the starting material feed up to 80 hrs⁻¹. Gas, containing 10% O₂ and 90% N₂ (a mixture of nitrogen and air) instead of oxygen, gave at the pressure 2 Barr the same result as that received at the presence of air at the normal pressure.

The duration of the incessant work of a catalyst with the volume speed of kerosene about 40 hrs⁻¹ was determined for the catalyst E as an example. Kerosene volume sweetened on the given catalyst until regeneration becomes necessary was measured. The regeneration of the catalyst was performed by air treatment at 500° C. for 2 hours, impregnation by solution of CuCl₂ and monoetanolamine in acetonitrile for 1.5 hours, and subsequent calcination at 100° C. The data demonstrating the stability of the catalytic activity before and after regeneration ar given in tab. 2.

TABLE 2

| Catalyst | T, ° C. | Kerosene sweetened, L/Catalyst, dm³ |
|---|---|---|
| E | 25 | 6200 |
| E | 40 | 6700 |
| E | 63 | 6000 |
| E | 80 | 5500 |
| E | 25* | 6800 |
| F | 25 | 750 |

*the space velocity of keroxene 25 hrs⁻¹.

It is seen from tab. 2, that catalysts prepared according to the invention are very stable. Catalyst F, not containing transition metal oxide, on the contrary, fails to maintain the necessary efficiency of sweetening already after 750 volumes of kerosene per 1 volume of the catalyst passed. The regeneration allows restoring the activity of a catalyst completely. The stability of the fresh and regenerated catalyst is the same.

1-10. (canceled)

11. A method of preparation of a catalyst comprising 0.2-5% of an oxide selected from the group consisting of an oxide of a transition metal of group Ib, an oxide of a transition metal of group Vb, an oxide of a transition metal of group VIb, an oxide of a transition metal of group VIIb, a nickel oxide, a cobalt oxide, and a mixture of at least two of said oxides; 1.5-20% of a transition metal salt; 0.5-20% of a nitrogen-containing organic compound; and an inert component up to 100%, comprising the steps of impregnating the inert compound with a solution of a transition metal salt; calcining a resulting product in airflow for metal oxide formation; and depositing the transition metal salt and the nitrogen-containing organic component from a solution in organic solvent, providing said inert component as a substance selected from the group consisting of an oxide of an element of group IIa, an oxide of an element of group III, an oxide of an element of group IV, an iron oxide, a chemical compound containing not less than 95% of at least one of said oxides, and a mixture of at least two of said substances, providing said nitrogen-containing organic compound as a compound selected from the group consisting of amine, amide, amino acid, alkanol amine, urea derivative, and a combination of at least two of said compounds.

12. A method as defined in claim 11; and further comprising selecting said transmission metal salt as a salt selected from the group consisting of chloride and bromide.

13. A method as defined in claim 11; and further comprising selecting said inert component as a component selected from the group consisting of silica, alumina, and a mixture thereof.
